(19) United States
(12) Patent Application Publication
(10) Pub. No.: US 2025/0152455 A1
(43) Pub. Date: May 15, 2025

(54) Device for Treating Neonatal Maladjustment Syndrome

(71) Applicants: Michael S. Etapa, Lexington, KY (US); Barbara A. Etapa, Lexington, KY (US)

(72) Inventors: Michael S. Etapa, Lexington, KY (US); Barbara A. Etapa, Lexington, KY (US)

(21) Appl. No.: 18/941,789

(22) Filed: Nov. 8, 2024

Related U.S. Application Data
(60) Provisional application No. 63/547,998, filed on Nov. 10, 2023.

(51) Int. Cl. A61H 9/00

(52) U.S. Cl. CPC A61H 9/0078; A61H 2203/03; A61H 2205/08

(57) ABSTRACT

This invention relates to a device that treats neonatal maladjustment syndrome (NMS). The device includes an alignment and protective covering that allows a user to align the compression device onto a newborn animal, and that provides protection from the pressure of the device. There is a bi-directional air bladder inside a pocket on the covering, and an adjustable chest strap that wraps around the animal. There is a padded chest protector on the chest strap to protect exposed areas of the animal. The chest strap securely attaches the covering to the animal, and when the bi-directional air bladder is inflated the chest strap imparts pressure onto the animal, which simulates the pressure of birth, and causes the animal to enter a somnolent state, simulating the state during birth, and reverses the effects of NMS.

### CROSS REFERENCE TO RELATED APPLICATIONS

This application claims priority to U.S. provisional application Ser. No. 63/547,998, filed on Nov. 10, 2023, and incorporated fully herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to a device for reversing neonatal maladjustment syndrome in animals, particularly equine foals. The device consists of an alignment covering, a strap to encircle the animal, and a bi-directional bladder to create compression on the upper chest and back area of the animal to reverse the effects of neonatal maladjustment syndrome.

### Description of the Related Art

During the birthing process, when horses and other hooved animals are born, the animal goes to sleep, or enters a somnolent state of unconsciousness, which prevents it from moving and injuring the mother with its hooves during the traumatic birthing process. A typical healthy foal birth should take at least 20 minutes. During this period there are a number of hormonal changes that occur. Some of these hormonal changes trigger the nursing and bonding process with its mother post birth. For this hormonal change to fully occur the foal has to be in a somnolent sleep stage while in the birth canal. If the birthing process happens too quickly the newborn foal may not have naturally experienced the hormonal changing process therefore causing what is technically known as Neonatal Maladjustment Syndrome (NMS). Also known as Dummy Foal. These foals may appear healthy when born but typically within 4-6 hours can mimic neurological abnormalities. Since the bonding hormonal changes have not fully occurred, dummy foals are often detached, disoriented, unresponsive, confused and usually have trouble nursing. If NMS is not detected and treated early enough as a result they often die.

Neonatal Encephalopathy (NE), and Neonatal Maladjustment Syndrome (NMS) are non-infectious neurological disorders that affect newborn foals. It is not completely understood but is linked to variable degrees of hypoxia before or after parturition. This theory is supported by the fact that NE and NMS appear more frequently in foals with rapid birth, abnormal birth, foals born by Cesarean Section, premature delivery, or foals that have been resuscitated for any reason. These foals appear healthy when they are born, but shortly thereafter exhibit neurological abnormalities. They are often detached, disoriented, unresponsive, confused, and have trouble nursing. As a result, they often die. It is presumed that these neurological abnormalities are caused by the fact that these neonates do not enter the state of somnolence during birth. Recent studies have shown that physical pressure on the foal while in the birth canal during a normal delivery signals the foal to stop producing the sedative inducing and causing the foal to wake up after being born. Foals that go through abnormal birth, rapid birth, or Cesarian Section, do not receive the same physical pressure during parturition, and therefore do not receive the same signals.

Dr. John Madigan DVM, of UC Davis School of Veterinary Medicine, was one of the first veterinarians to conduct research into NMS. He determined that applying pressure on a foal's chest could cause it to enter a somnolent phase which would mimic the somnolent phase of the actual birth, and could prevent or overcome NMS. Dr. Madigan developed a rope harness that could be placed around the chest, neck, and shoulders of a foal and that would create tension and pressure on the chest to put the foal to sleep. Dr. Madigan is a co-inventor of two patents, U.S. Pat. Nos. 9,339,433 and 9,724,262 that describe the NMS syndrome in detail, and provide therapies to reverse the effect. Both involve the process for identifying the malady in equine foals, and either administering a therapeutic drug, a 5α reductase inhibitor, and/or subjecting the foal to squeezing with a rope around the mid-thorax. This rope squeezing method is often referred to as the “Madigan Foal Squeeze.”

While this is often a successful treatment, there are a number of drawbacks. One drawbacks is that the ropes can harm the new born animal, and the compression has to done with care and precision or the animal can be injured. Another is that there is no specific method to determine the pressure applied to the rope and thus imposed onto the animal. A third is that the rope wrapped around the mid-thorax of the animal places pressure on the ribs but also the soft underbelly or stomach area, which can potentially harm the animal. Because of this, the use of the “Madigan Foal Squeeze” is almost always done by trained veterinarians and almost always in a fully equipped veterinarian hospital of facility. There is a need, therefore, for a device that can accomplish this procedures safely and humanely, without the potential for injury to a young animal, and accomplished with minimal training.

### SUMMARY OF THE INVENTION

This invention relates to a device that treats, or reverses, the effects of NE or MNS, and also overcomes many of the issues with the prior art. It includes an alignment and protective covering that allows a user to easily align the compression device onto a newborn animal such as an equine foal, and that also provides a protective covering for the animal. There is an adjustable chest strap attached to the alignment covering, wherein the alignment covering ensures that the chest strap is properly positioned on the animal. The chest strap has a width of one to three inches to prevent injury to the animal, but the protective covering also helps diffuse the pressure of the chest strap to further prevent injury. There is also a padded chest protector attached to the chest strap that is placed in the area where the alignment covering does not cover, to ensure that the chest strap does not press directly against the animal's belly or area not protected by the ribs. There is an elongated pocket located in the center of the alignment covering, which places it over the spine of the animal when in place, and a bifurcated, bi-directional air bladder inserted into the elongated pocket. The chest strap is placed over the pocket. When the alignment covering is in place, the bi-directional air bladder is aligned against the upper ribs of the animal, just behind the shoulders.

In use, the alignment covering is placed over the animals back and aligned so that the chest strap is positioned just behind the animal's shoulders. There are two front attachments that are secured in front below the neck of the animal, and the chest strap is attached. The sides of the alignment covering are brought around the lower belly of the animal, and the padded chest protector is positioned over the exposed belly of the animal, and the chest strap is cinched snugly but not tight. The pressure is applied by inflating the bi-directional air bladder and when the proper pressure is achieved the animal will enter the somnolent state. There is a pressure gauge to control and monitor the pressure applied to the animal. In some embodiments there are also heart rate and blood pressure gauges integrated into the alignment covering to provide medical monitoring of the animal while in the somnolent state.

The device is an alignment and compression covering for treating neonatal maladjustment syndrome in animals. The device includes an alignment covering that is sized and configured to be placed on a neonate animal such as a foal. The alignment covering including a bladder pocket centered thereon and configured to be centered over the spine of the animal, and a bi-directional inflatable air bladder that is placed within said bladder pocket, and configured to be placed on either side of the animal's spine such that when inflated it presses against the animal's rib cage immediately on either side of the spine. The bi-directional inflatable air bladder including an air pump to inflate said bi-directional inflatable air bladder and a pressure gauge to measure and indicate the pressure within said bi-directional inflatable air bladder. There is also a chest strap attached to said alignment covering over said bladder pocket, said chest strap of a length to fully encircle the neonatal animal and securely attach to the alignment covering with a chest strap latch. There is a padded chest protector slidably attached to said chest strap and configured to be placed against the lower rib cage of the neonatal animal. The alignment covering also includes a right neck wrap with a cinch strap and a left neck wrap with a strap attachment, configured to encircle the animal's neck when the alignment covering is place on the animal, said cinch strap attachable to said strap attachment to attach the left neck wrap to the right neck wrap around the animal's neck.

When a neonatal animal, such as a newborn foal, exhibits symptoms of maladjustment syndrome, the alignment covering is draped over the animal and attached around the neck by attaching the right neck wrap to the left neck wrap, and then further attached by running the chest strap around the animal, placing the padded chest protector over the lower ribcage of the animal. The chest strap is tightened around the animal, and secured by attaching the chest strap to a chest strap latch. The bi-directional inflatable air bladder is then inflated with the air pump to the desired pressure, thus simulating the pressure of the birthing process and causing the neonatal animal to enter a somnolent state, and maintaining the pressure for the time needed to fully reverse the neonatal maladjustment syndrome.

### BRIEF DESCRIPTION OF THE DRAWINGS

FIG. 1 is a perspective top view of the alignment covering showing the main components of the invention in association with a representative animal.

FIG. 2 is a side view of the alignment covering positioned on a foal.

FIG. 3 is a detailed view of the bi-directional air bladder and components.

FIG. 4 is a cut away front view of the alignment covering showing the positioning of the bi-directional air bladder, covering and chest strap on the foal.

FIG. 5 is a perspective view of the alignment covering on a foal in the somnolent state.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

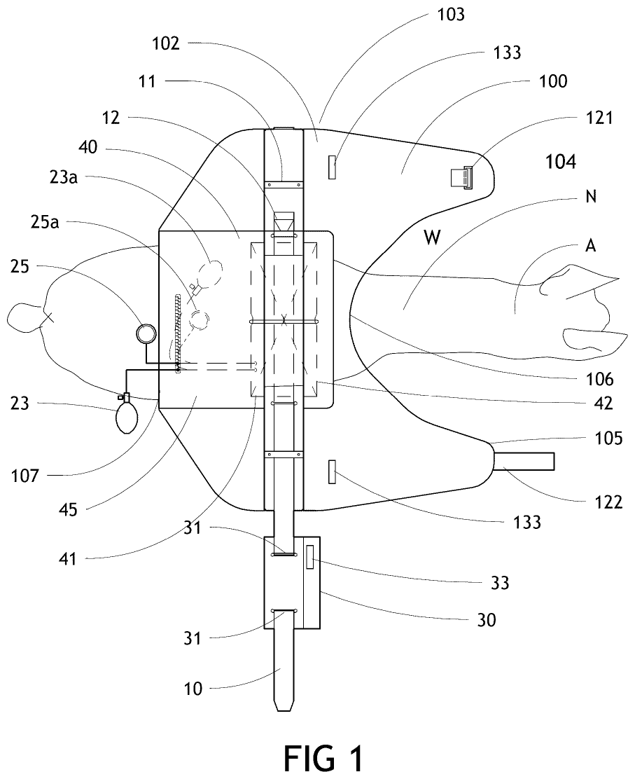

FIG. 1 is a top view of the alignment and protective covering 100, referred to herein simply as the alignment covering 100, showing it's configuration and the main components of the invention. FIG. 1 also includes the silhouette of an animal A, in particular a horse, to show the general position of the alignment covering 100 when on the animal. The alignment covering 100 is, in the preferred embodiment, made from a synthetic rubber fabric, of a type commonly used for medical equipment, that is waterproof and easy to clean, and is soft enough to bend and adhere and provide a form-fitting covering on the animal. The alignment covering 100 has an underside 103 that is placed on the horse, and a topside 102, where the various components are attached and operate. The alignment covering 100 is roughly a fat “c” shape, with the two front protrusions, a left neck wrap 104 and a right neck wrap 105, the front inlet edge 106, and the back 107.

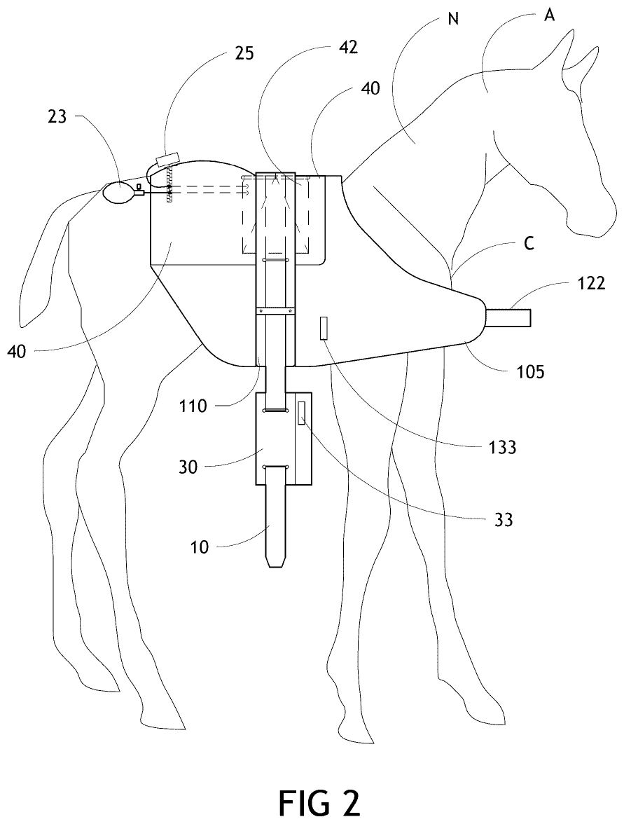

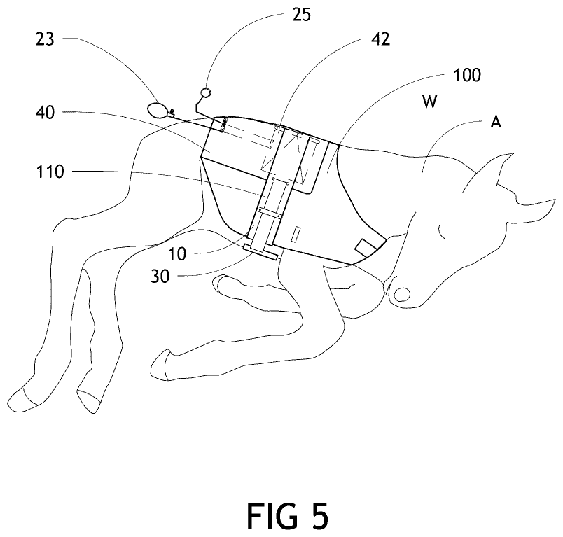

As seen in FIG. 1, FIG. 2, and FIG. 5, the alignment covering 100 is draped over the animal with the front inlet edge 106 just behind the animal's withers W, and configured so that the left neck wrap 104 and right neck wrap 105 are attached around the neck N of the animal, and attached in front just below the neck N. There is a cinch strap 122 attached to the right neck wrap 105 and a cinch strap attachment 121 attached to the left neck wrap 104. When placed on the animal A, the alignment covering 100 is secured initially by securing the cinch strap 122 to the cinch strap attachment 121, which helps secure and properly align the alignment covering 100. In one embodiment the cinch strap 122 is a fabric strap and the attachment 121 is a simple loop and the strap 122 is secured by running through the loop. In the preferred embodiment the cinch strap attachment 121 is a standard belt clip. The left neck wrap 104 and right neck wrap 105 do not need to be tightly fastened.

There is an equipment attachment sleeve 40 attached to the topside 102 of the alignment covering 100, and positioned on the center back of the alignment covering 100. In the preferred embodiment the equipment attachment sleeve 40 is made from the same material as the alignment covering 100, but any suitably soft, flexible, and water resistant material can be used. The equipment attachment sleeve 40 is attached to the topside 102 to create a storage pocket 45 and a bladder pocket 42. In the preferred embodiment, this piece of material is 12 inches by 14 inches, but this can vary depending upon the size of the animal and the equipment needs. The equipment attachment sleeve 40 is attached by sewing around the outside edges onto the top of the alignment covering 100. The section of material is sewn around the outsides to attach the equipment attachment sleeve 40 to the alignment covering 100 with the back 107 left open, and then sewn partially across the middle, leaving an unsewn portion to create an opening 41 to the bladder pocket 42. The bladder pocket 42 is sized to accommodate the bi-directional air bladder 20. In the preferred embodiment the bladder pocket 42 is 6 inches wide and 12½ inches long, and the opening 41 is approximately six inches wide, or big enough to slide the bi-directional air bladder 20 into the bladder pocket 42. The storage pocket 45 sits just next to the bladder pocket 42 and under the same section of material that creates the equipment attachment sleeve 40. It is secured at the inside edge by the same sewing thread as that segmented the bladder pocket 42. It is closably openable on the outside edge at the back 104 of the alignment covering 100, and in the preferred embodiment is closable by a paired strip of hook and loop material or zipper to create a pocket closure 46. The pocket closure 46 opening allows the user to insert the bi-directional bladder 20 into the bladder pocket 42, and then the storage pocket 45 provides a place for the bi-directional bladder air pump 23 and air pressure gauge 25 to be stored while not in use. In FIG. 1 the dashed depiction of the air pump 23a and pressure gauge 25a show those items inside the storage pocket 45.

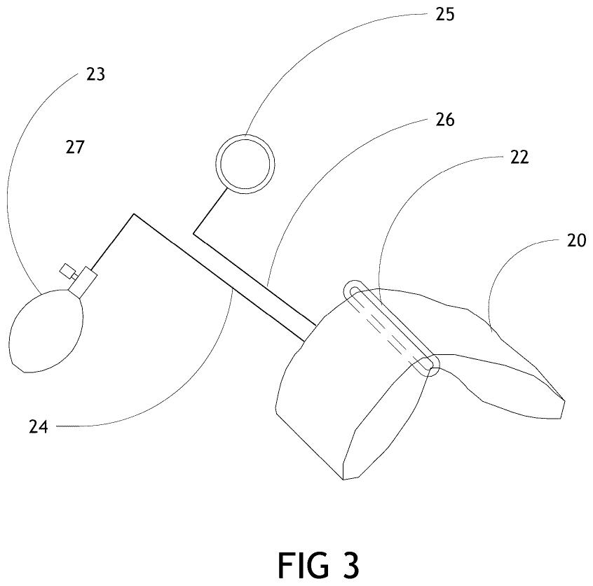

FIG. 3 is a detailed view of the bi-directional air bladder 20. In the preferred embodiment the bi-directional bladder 20 is the same type of air bladder as for a typical blood pressure monitor. It is typically five and one-half inches wide and twelve inches long, and typically made of air-tight coated rubber or soft synthetic plastic, and when inflated is roughly three inches thick at the widest portion, which is generally the middle of the bladder. The bi-directional bladder 20 includes the same type of controllable air pump 23 that is attached to the bladder 20 by an air-tight pump hose 24, and includes a screw controlled shut off valve 27 that allows the user to pump air into the bladder, then turn the screw to prevent the air from leaving the bladder. Such air pumps for inflatable bladders, such as a common blood pressure cuff, are common and well known. There is also an integrated air pressure gauge 25 that is connection to the bladder 20 by a gauge tube 26. Such air pressure gauges and also common and well known. There is an elongated D-ring 22, that is slid over the bladder 20 and placed in the middle of the bladder 20. In the preferred embodiment the D-ring is made of metal and is six inches long with a one-half inch opening to constrict the middle portion of the air bladder 20 to bifurcate it. In an alternate embodiment the D-ring can be secured, and in another embodiment there can be stitching or other internal structures to bifurcate the bladder 20. The D-ring 22 is placed in the middle of the bladder 20, as shown in FIG. 3, so that, when inflated, the middle stays narrow, and the bladder 20 inflates in two pouches to create the bi-directional air bladder 20. The bifurcated air bladder 20 is slid into the bladder pocket 42 and flattened, with the D-ring 22 centered in the pocket 42 and hence on the alignment covering 100.

The alignment covering 100 also includes a chest strap 10 that is attached thereto. In one embodiment the chest strap 10 can be attached to the alignment covering 100 by sewing. In the most preferred embodiment there is a strap attachment band 110, which is an elongated section of the same material as the alignment covering 100, that is wider than the chest strap 10 and includes loops 11 to hold the chest strap 10. The strap attachment band 110 is attached laterally, from side to side, across the alignment covering 100, and across the top of the equipment attachment sleeve 40, so that the chest strap 10 is over, on top, of the bi-directional air bladder 20. In the preferred embodiment the strap attachment band 110 is attached by sewing, but it can be attached by other conventional means including gluing. The chest strap 10 is a fabric strap, typically between one and three inches wide, and is significantly longer than the overall width of the alignment covering 100, and long enough to fully encircle the ribcage at the lower chest of the animal A, and to be secured around and one the attachment on the alignment covering 100. The width of the chest strap 10 allows the applied pressure, described in detail below, to be diffused or spread over a broader width than the rope of the prior art. The addition of the strap attachment band 110 further diffuses or spreads out the applied pressure onto the alignment covering 100, which also diffuses the pressure to minimize the potential to injure the animal. The chest strap 10 is run around the body of the animal, typically near the bottom of the rib cage, though this can vary depending upon the size of the animal, and is attached back to the alignment covering 100.

The chest strap 100 can be attached to the alignment covering 100 once it has encircled the animal's body, in any conventional manner as other similar belts or straps, which can include a common belt buckle with loop and holes, a single or paired chest strap loop 11, hook and loop Velcro® type material, or other conventional strap attachment means. In the preferred embodiment the chest strap 10 is secured by a standard strap latch 12, which is a common slide clip that is snapped down to secure the chest strap 10 in position. In use the chest strap 10 is attached securely and hand-tight snug, but without tightening or applying excessive pressure on the animal. This allows the pressure to be applied in a controlled manner by the bi-directional air bladder 20 as described below.

There is also a padded chest protector 30 attached to the chest strap 10. The padded chest protector 30 as the name implies, is a section of padded material. In one embodiment there is a section of fabric, typically nylon, but leather can also be used, with padding attached. In the most preferred embodiment the padded chest protector 30 is eight inches long and five inches wide, but can be bigger if the need arises. The chest protector 30 is constructed from a piece of heavy fabric or leather with a similarly sized piece of padding material covered with a lighter fabric, to created a section of padded material that will be placed against the chest or belly of the animal when the alignment covering 100 is in place. As seen in FIG. 2 and FIG. 5, this is at the belly roughly at the end of the rib cage of the animal. In the preferred embodiment there are two slits 31 in the upper fabric of the padded chest protector 30, and the chest strap 10 slides through the two slits 31. This allows the chest protector 30 to slide on the chest strap 10, which allows it to be movable to be properly aligned. It will be positioned on the chest or belly area of the horse, which is more fragile than the rib area, and protects the animal's lower ribs and disperses the pressure of the chest strap 10 to a larger surface area. In a preferred embodiment wireless health monitors can be attached to the padded chest protector 30 in a small pocket 33. In one embodiment there is a similar small pocket 133 on either side of the alignment covering 100 to hold a second or a third wireless health monitor. Such wireless health monitors are well known, and can be used to measure heart rate, blood pressure, body temperature, and the like. Such wireless health monitors will be pressed against the animal to measure it's heart rate, blood pressure, and other vital functions, and will transmit this data wirelessly to a monitor, or through Bluetooth® to a tablet or smartphone with a connecting app.

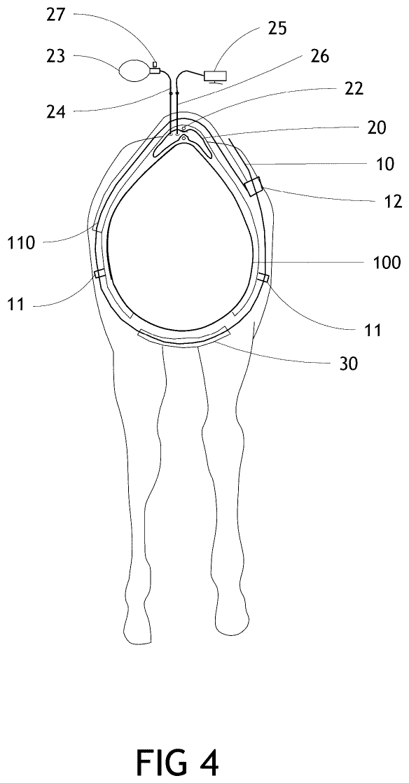

FIG. 4 is a cut away view of a horse with the alignment covering 100 placed over the back of the animal A. As can be seen, the alignment covering 100 comes to the lower portion of the animal's ribs. The chest strap 10 fully encircles the animal, and the padded chest protector 30 is placed at the bottom of the animal. In this position the D-ring 22 is aligned over the spine of the animal, and the two sides of the bi-directional bladder 20 are on either side of the animal's spine. When the bi-directional bladder 20 is inflated it presses on the upper ribs near where they meet the spine and on either side of the spine. Since the chest strap 10 has secured the alignment covering 100 around the animal and also is over the bi-directional air bladder 20, inflating the bi-directional bladder 20 will create pressure around the entire mid-section of the animal, which will simulate the pressure of the birth canal and cause the animal to enter the somnolent state.

The positioning of the bi-directional air bladder 20 ensures that the main pressure is on the upper rib area of the animal, which is one of the strongest areas of the new-born animal's body. Inflating the bladder 20 will put pressure on the entire chest strap 10. The chest strap 10 is, in the preferred embodiment, placed on the attachment band 110, and the attachment band 110 is placed on the alignment covering 100. Each helps diffuse the pressure of the chest strap 10 on the animal's body. The alignment covering 100 sits against the animal's body and diffuses the pressure of the chest strap 10 on the body, and the padded chest protector 30 further pads and protects the chest strap 10 from exerting undue pressure on the belly or lower ribs of the animal. The air pressure gauge 25 allows the user to monitor and therefore apply a specified pressure to the animal's body. And the integrated health monitors allow the user to monitor the animal's heart rate, body temperature, and blood pressure during the procedure.

To use the device, the animal will be carefully observed after birth. Symptoms of NE or NMS can be obvious to the trained eye in as little as 4 to 6 hours after birth. However, in some cases the foal can appear normal for the first day, but symptoms will develop 24 to 36 hours after birth. If the animal A exhibits symptoms of NE or NMS the alignment covering 100 will be placed on the neonate animal with the indent 106 just behind the withers W of the animal A, and the neck wraps 104 and 105 secured in front with the cinch strap 122 and attachment 121. The chest strap 10 will then be wrapped around the midsection of the animal A, and secured with the strap latch 12. The padded chest protector 30 will be aligned at the center bottom of the animal's belly to protect the lower rib cage, and the chest strap 10 will be tightened and secure in place with the strap latch 12. Then air will be pumped into the bi-directional air bladder 20 by means of the air pump 23, and once the desired pressure is obtained, as shown by the pressure gauge 25, the shut off valve 27 is closed. Often the appropriate pressure is only determined when the foal enters the somnolent stage. At this point the neonate will enter the somnolent stage as seen in FIG. 5. The pressure will be maintained, as indicated by the pressure gauge 25, to keep the neonate in the somnolent stage for between fifteen and twenty minutes, to fully reverse the NE or NMS. The heart rate and blood pressure can be monitored to ensure that the animal does not become distressed in any manner. Also, in some cases the animal's heart rate will return to normal to indicate that the NE or NMS have been fully reversed.

We claim:

1. A device for treating neonatal maladjustment syndrome in animals, the device comprising:
an alignment covering to properly position the device on the animal;
a bi-directional air bladder disposed within said alignment covering,
a chest strap attached to said alignment covering over said bi-directional air bladder, said chest strap encircling the animal, and
said bi-directional air bladder configured to inflate to create compression on the upper back area of the animal, and said chest strap create compression around the chest of the animal to simulate the pressure encountered in the birthing process and to treat and reverse neonatal maladjustment syndrome.

2. The device for treating neonatal maladjustment syndrome in an animal of claim 1, wherein said animal is a foal.

3. The device for treating neonatal maladjustment syndrome in an animal of claim 1, wherein said bi-directional air bladder includes an air pump with shut off valve to inflate the bi-directional bladder, and a pressure gauge to monitor the pressure of the bladder.

4. The device for treating neonatal maladjustment syndrome in an animal of claim 1 wherein the chest strap is between 1 and 3 inches wide, with this width to spread the pressure across a wider area to prevent injury to the animal.

5. The device for treating neonatal maladjustment syndrome in an animal of claim 1, further including a pocket to hold said bi-directional air bladder and centered on said alignment covering to position the bi-directional air bladder over the spine of the animal.

6. The device for treating neonatal maladjustment syndrome in an animal of claim 4, further including an attachment band attached over said pocket and to said alignment covering, wherein said chest strap is attached to said attachment band by a multiplicity of loops, wherein the pressure of said chest strap is diffused by said attachment band and said alignment covering to prevent injury to the animal.

7. The device for treating neonatal maladjustment syndrome in an animal of claim 1, further including a padded chest protector slidably attached to said chest strap, said padded chest protector movably placed on the animal's body between the ends of the alignment covering to protect the animal from injury.

8. The device for treating neonatal maladjustment syndrome in an animal of claim 6 further including pockets on said alignment covering and said padded chest protector, said pockets configured to hold wireless health data monitors to monitor the vital signs of the animal.

9. An alignment and compression covering for treating neonatal maladjustment syndrome in animals, said alignment and compression covering comprising:
an alignment covering sized and configured to be placed on a neonate animal;
said alignment covering including a bladder pocket centered thereon and configured to be centered over the spine of the animal;
a bi-directional inflatable air bladder placed within said bladder pocket, and configured to be placed on either side of the animal's spine such that when inflated it presses against the animal's rib cage immediately on either side of the spine;
said bi-directional inflatable air bladder including an air pump to inflate said bi-directional inflatable air bladder and a pressure gauge to measure and indicate the pressure within said bi-directional inflatable air bladder;
a chest strap attached to said alignment covering over said bladder pocket, said chest strap of a length to fully encircle the neonatal animal and securely attach to the alignment covering with a chest strap latch;
a padded chest protector slidably attached to said chest strap and configured to be placed against the lower rib cage of the neonatal animal;
said alignment covering including a right neck wrap with a cinch strap and a left neck wrap with a strap attachment, configured to encircle the animal's neck when the alignment covering is place on the animal, said cinch strap attachable to said strap attachment to attach the left neck wrap to the right neck wrap around the animal's neck;
wherein, when a neonatal animal exhibits symptoms of maladjustment syndrome the alignment covering is draped over the animal and attached around the neck by attaching the right neck wrap to the left neck wrap, and then further attached by running the chest strap around the animal, placing the padded chest protector over the lower ribcage of the animal, tightening the chest strap, and securing the chest strap with the chest strap latch; inflating the bi-directional inflatable air bladder with the air pump to the desired pressure, thus simulating the pressure of the birthing process and causing the neonatal animal to enter a somnolent state, and maintaining the pressure for the time needed to fully reverse the neonatal maladjustment syndrome.

10. The alignment and compression covering of claim 9, further including a strap attachment band attached to the alignment covering, said strap attachment band including loops to hold the chest strap, and wherein the strap attachment band will diffuse the pressure of the chest strap to prevent injury to the animal.

11. The alignment and compression covering of claim 9, further including a chest protector pocket and an alignment covering pocket, and at least one wireless health monitor disposed in either of said pockets to monitor the vital signs of the animal.

12. The alignment and compression covering of claim 9, wherein the animal is a foal.
